(19) United States
(12) Patent Application Publication
(10) Pub. No.: US 2004/0083795 A1
(43) Pub. Date: May 6, 2004

(54) Pressure sense gauge assembly for attachment to automatic spark plug

(76) Inventors: Raymond O. Butler JR., Anderson, IN (US); Diane E. Hageman, Fishers, IN (US); Ronald J. Kiess, Decatur, IN (US)

Correspondence Address: JIMMY L. FUNKE, DELPHI TECHNOLOGIES, INC., Legal Staff, Mail Code: 480-410-202, P.O. Box 5052, Troy, MI, 48007-5052, US

(21) Appl. No.: 10/694,871

(22) Filed: Oct. 28, 2003

Related U.S. Application Data
(63) Continuation-in-part of application No. 10/213,636, filed on Aug. 6, 2002, now Pat. No. 6,668,632.
Application No. 10/213,636 is a continuation-in-part of application No. 09/799,362, filed on Mar. 5, 2001.

(51) Int. Cl. G01L 23/22

(52) U.S. Cl. 73/35.12

(57) ABSTRACT

An ignition coil, spark plug, and pressure sense assembly for an internal combustion engine are, in a preferred embodiment, integrated into a single assembly and mounted directly on a plug hole of an internal combustion engine. A pressure sense assembly is welded to a spark plug shell which serves as a pressure member. The pressure sense assembly includes a base plate onto which first and second pairs of strain gauges are printed using a thick film ink process (piezoresistive) in a full bridge arrangement. The geometry of the base plate and the fashion in which it is welded to the shell allow one pair of the gauges to function as strain sensing elements while the other pair can function for temperature compensation. Changes in the pressure in the combustion chamber deform the shell, causing a corresponding change in the bridge producing the pressure signal.

### RELATED APPLICATIONS

This application is a continuation-in-part (CIP) of U.S. application Ser. No. 10/213,636 filed Aug. 6, 2002 (attorney Docket No. DP-307,425), now pending, which is in turn a continuation-in-part (CIP) of co-pending U.S. application Ser. No. 09/799,362 filed Mar. 5, 2001 (attorney Docket No. DP-302,527), now pending.

### INCORPORATION BY REFERENCE

Application Ser. Nos. 10/213,636 filed Aug. 6, 2002 and 09/799,362 filed Mar. 5, 2001 are both hereby incorporated by reference.

### TECHNICAL FIELD

The present invention relates to a spark generating apparatus with a pressure sensor.

### BACKGROUND OF THE INVENTION

An ignition coil for an internal combustion engine that is installed directly on an engine and that is directly coupled with spark plugs is known (e.g., a “pencil” coil). However, such conventional ignition coils and/or spark plugs do not generally incorporate a pressure sensor. However, a pressure sensor mounted on a spark plug is known as disclosed in U.S. Pat. No. 5,672,812 to Meyer.

Meyer discloses a magnetostrictive pressure sensor device attached to a spark plug shell. The disclosed approach, however, requires a magnetized spark plug shell. This increases cost, and subjects the resulting signal to noise due to environmental factors (e.g., magnetic and electrical noise in an automotive environment).

U.S. Pat. No. 6,122,971 to Wlodarczyk discloses use of a fiber optic for a pressure sensor integrated with a spark plug. U.S. Pat. No. 5,955,826 to Suzuki et al. disclose a spark plug with an opening in the threads to allow some combustion gases into a sealed chamber that houses a piezoelectric sensor for pressure sensing. This method has a disadvantage in that the opening can become clogged over time, impairing performance.

U.S. Pat. No. 6,119,667 to Boyer et al. disclose an integrated spark plug/ignition coil with a pressure sensor for an internal combustion engine. The sensor is disclosed as a magnetostrictive sensor, and is further disclosed as using a radially polarized biasing magnet and a sensing winding. As with the Meyer device, additional components such as a magnet are needed, which may increase cost and complexity. Thus, all of the foregoing are considered increased cost alternatives with drawbacks.

Resistive ink (hereinafter “piezoresistive thick film ink) may be “printed” directly onto a spark plug shell to form a strain gauge as the transducer that picks up strains in the shell due to combustion pressure in the engine cylinder. There are several challenges, however. First, for the thick film ink to satisfactorily chemically bond with the shell and maintain adhesion throughout its life, the material for the shell must be selected with care, for example, a 430 stainless steel, which is relatively expensive. Since the entire shell would be made from this material, the cost may be increased. Second, another consequence of printing directly onto the shell is that the entire spark plug assembly or the separate shell will be subjected to temperatures of 850° C. or higher. At such high temperatures, the steel anneals and a preload on an internal spark plug seal may be lost. Third, printing directly onto the shell involves a printing process that must be specialized to print on each individual spark plug shell and such process must also be capable of printing onto a round surface (i.e., the shape of the shell). Such a process is not conducive to high volume production. Finally, for temperature compensation purposes, in a full bridge configuration (i.e., the strain gauge(s) may be arranged in a bridge), it is desirable to have two (2) of the four (4) strain gauges subject to either zero strain or a strain that is principally compressive in nature. The spark plug shell experiences a small compressive strain in the circumferential (also called “hoop”) direction, but is principally put in tension in the axial direction. Due to the nature of the strains in the shell, combined with the microstructural properties of piezoresistive inks, a second nonpiezoresistive ink or two chip thermistor would have to be used to satisfactorily implement a full bridge having temperature compensation.

There is therefore a need for an improved spark generating apparatus with pressure sensing for an internal combustion engine that minimizes or eliminates one or more problems as set forth above.

### SUMMARY OF THE INVENTION

An object of the present invention is to solve one or more of the problems as set forth in the Background. The invention involves “printing” one or more strain gauges onto a substrate or base plate. The base plate with strain gauges is thereafter attached, such as by welding or the like, to the spark plug shell. The present invention addresses the shortcomings and challenges set forth in the Background. First, cost is reduced since the entire spark plug shell need not be formed of expensive material (e.g., such as 430 stainless steel), just the base plate. Second, since it is the base plate/printed strain gauges that are “fired” to high temperatures, the spark plug seals are not compromised. Third, the base plate can be flat and formed on a die having a plurality of individual base plates (e.g., 16 base plates/strain gauge assemblies), which makes it suitable for high volume production. Finally, the base plate can have a predetermined geometry, and the strain gauges so arranged on the plate, and the base plate affixed to the shell such a first pair of strain gauges are in an axial load path while a second pair of transversely disposed strain gauges are out of the axial load path. This inventive assembly provides a direct and simplified structure for implementing temperature compensation.

These and other objects, advantages and features are obtained by an apparatus for measuring cylinder pressure in accordance with the present invention. The apparatus provides a novel and nonobvious way of associating a strain gauge(s) with a spark plug (or glow plug). In a preferred embodiment, the apparatus is provided for initiating a spark and that is suitable for installation in a cylinder of an spark ignited internal combustion engine. In such an embodiment, the pressure sensing spark plug may be integrated with a pencil coil type ignition system or provided as a standalone device (e.g., with electronics).

In accordance with the present invention, an apparatus is provided for detecting a pressure in a cylinder of an internal combustion engine. The apparatus includes an annular shell and a pressure sense assembly. The shell extends along a longitudinal, main axis and is configured to be removably attached to the engine. At least a portion of the apparatus is subjected to the pressure in the cylinder. The pressure sense assembly includes a base plate. The base plate has a central body portion. The base plate includes at least one strain gauge formed thereon. The base plate is affixed to the shell.

In a preferred embodiment, the base plate is affixed to the shell. This affixation approach establishes an axial load path over the area of the base plate subtended in an axial direction. In such an embodiment, a second longitudinal axis is established to substantially, symmetrically divide the base plate. At least first and second strain gauges are formed in the axial strain load path.

In a still further preferred embodiment, the base plate is affixed to the shell along top and bottom edges of first and second opposing tabs. The tabs extend axially away from the central body portion. The axial load path extends over an area of the base plate subtended in an axial direction by the first and second tabs. The second longitudinal axis passes through the first and second tabs, the first and second strain gauges being located on each side of the second axis. A second pair of strain gauges are formed on the base plate circumferentially outwardly (i.e., transversely) of the axial strain load path mentioned above. The transversely-arranged second pair of strain gauges experience little or no axial strain and thus may be advantageously used for temperature compensation.

A spark generating assembly for initiating combustion and detecting a pressure in a cylinder is also presented.

### BRIEF DESCRIPTION OF THE DRAWINGS

Additional objects and advantages of the present invention will be more readily apparent from the following detailed description of preferred embodiments thereof when taken together with the accompanying drawings in which.

FIG. 1 is an exploded, perspective view of a preferred embodiment together with an engine and a control unit.

FIG. 2 is a sectional view, showing in greater detail, the integrated spark plug and coil with pressure sensor embodiment of FIG. 1.

FIG. 3 is a side view that shows a shell portion of the embodiment of FIG. 2 with a pressure sense assembly affixed in an exemplary location.

FIG. 4 is a plan view that shows, in greater detail, the pressure sense assembly of FIG. 3, including a base plate and a plurality of strain gauges, in a preferred embodiment.

FIG. 5 is a perspective view that shows an alternate embodiment of the pressure sense assembly of FIG. 4, having a curved base plate.

FIG. 6 is a perspective view that shows another alternate embodiment of the pressure sense assembly of FIG. 4, having a hole formed there through.

FIG. 7 is a plan view that shows an still another alternate embodiment of the pressure sense assembly of FIG. 4, having axially extending slots.

FIG. 8 is a plan view showing a plate having multiple pressure sense assemblies formed thereon.

FIG. 9 is a schematic view of an exemplary bridge circuit.

FIGS. 10-11 are schematic views of alternative bridge circuits.

### DETAILED DESCRIPTION OF THE PREFERRED EMBODIMENT

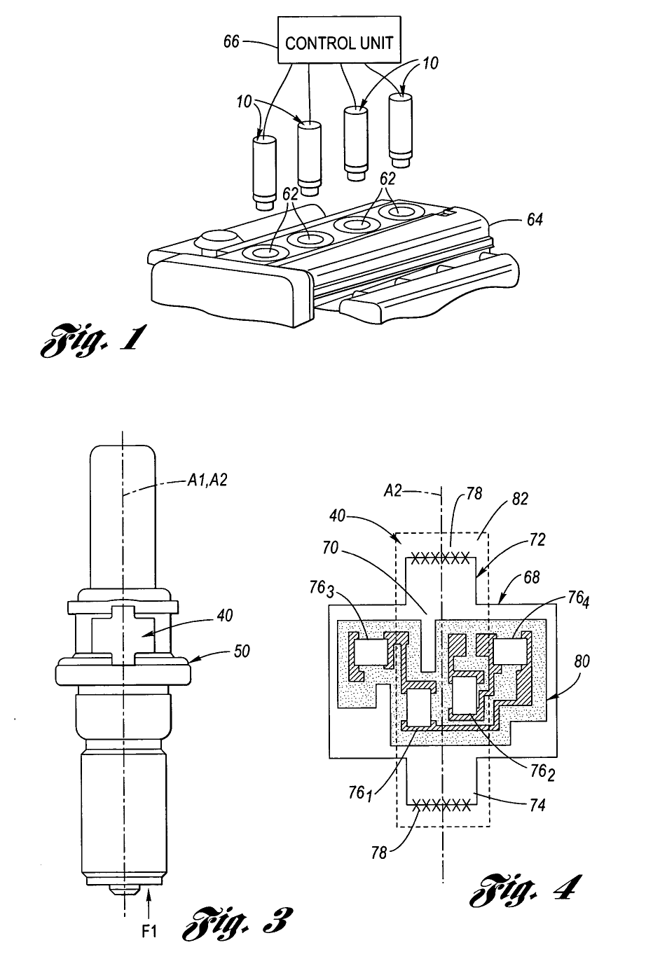

Referring now to the drawings wherein like reference numerals are used to identify identical components in the various views, FIG. 1 shows an exemplary environment in which the present invention may be used. Particularly, one embodiment of the present invention is in an implementation of an integrated ignition coil, spark plug and pressure sense assembly 10. The assembly 10 is adapted for installation to an opening 62 of a conventional spark-ignited internal combustion (IC) engine 64. This installation may be accomplished using a threaded spark plug shell so that it is in threaded engagement with corresponding threads of the spark plug opening 62. This installation thus provides for removable attachment. Opening 62 is in communication with a combustion cylinder (not specifically shown). This results in an arrangement such that at least a portion of the apparatus is subjected to the pressure variations in the combustion cylinder. The multiple assemblies 10 may be coupled to a control unit 66, for control of the ignition event, as well as for the monitoring of the pressure signal. It should be understood that although the illustrative embodiment involves an assembly for a spark-ignited IC engine, other variations are possible without departing from the spirit and scope of the present invention. For example, the invention may be applied to a glow plug for use in a diesel cycle engine. In a still further embodiment, the invention may be packaged as a standalone spark plug/pressure sense assembly, separated from an ignition coil.

FIG. 2 is a section view that illustrates assembly 10 of FIG. 1 in greater detail. Assembly 10 is generally cylindrical shaped having a first, longitudinal axis designated “A1.” Assembly 10 includes a transformer portion 12 comprising a core 14, a primary coil 16, a secondary spool 18, a secondary coil 20, a connection portion 22 comprising a high-voltage boot 24; a control circuit portion 26 comprising an assembled connector portion 28 and a circuit interface portion 30; a coil case 32, an outer housing or shield 34 comprising a fastening head 36; a spark plug assembly 38, and a pressure sense assembly 40.

Spark plug assembly 38 further includes a central electrode 42 having a first end 44 and a opposing second end 46, an insulator portion 48, and a shell 50 comprising (i) a second, ground electrode portion 52, (ii) a threaded portion 54 and (iii) a center portion 56. Insulator 48 includes a central bore 58. A seal 60 is provided between insulator 48 and an inner surface of shell 50 to seal out combustion gases. Pressure sense assembly 40 has a second longitudinal axis designated “A2” extending there through. Generally, the foregoing elements (other than pressure sense assembly 40) may comprise conventional components, and therefore a detailed description of such conventional components will be deferred until after a detailed description of pressure sense assembly 40.

FIG. 3 is side view of shell 50 having pressure sense assembly 40 affixed thereto. Pressure sense assembly 40 is configured to produce a signal indicative of a pressure level in the cylinder of engine 64. Shell 50 is the member through which strains arising from such pressure changes are measured. From the perspective illustrated in FIG. 3, the first longitudinal axis A1 and the second longitudinal axis A2 are aligned, although axis A1 is radially offset from axis A2 (the offset being best shown in FIG. 2). FIG. 3 shows an axially directed force designated “F1.” Force F1 is the force resulting from pressure in the combustion cylinder as applied to the bottom portion of the assembly 10, mainly applied to the insulator. Force F1 is transferred ultimately to the shell 50, and is resolved principally as an axial strain of shell 50, but also includes a circumferential or hoop strain in shell 50.

The present invention contemplates that assembly 50 will be formed with at least one strain gauge formed thereon. In such an embodiment, the strain gauge may be electrically connected in a bridge circuit arrangement (see FIGS. 9-11 for example) wherein the input bias and the output pressure signal may be communicated by way of wires (preferred) or by use of a flex circuit (which are known). The wire approach has the advantage of reduced cost (compared to a flex circuit). The flex circuit has improved flexibility in managing RFI and the like. The described arrangement will indicate the cylinder pressure of a running or motoring engine. The force F1 applied to the center insulator of the spark plug arising due to the pressure increase during combustion will cause a deflection of the insulator, which results in a strain in the spark plug shell 50. Such flexure will result in a change of resistance of the one or more strain gauges in accordance with the detected strain, and hence serve to vary the output of the bridge. A direct correlation of cylinder pressure to resistance change is measurable during the combustion cycles of the engine.

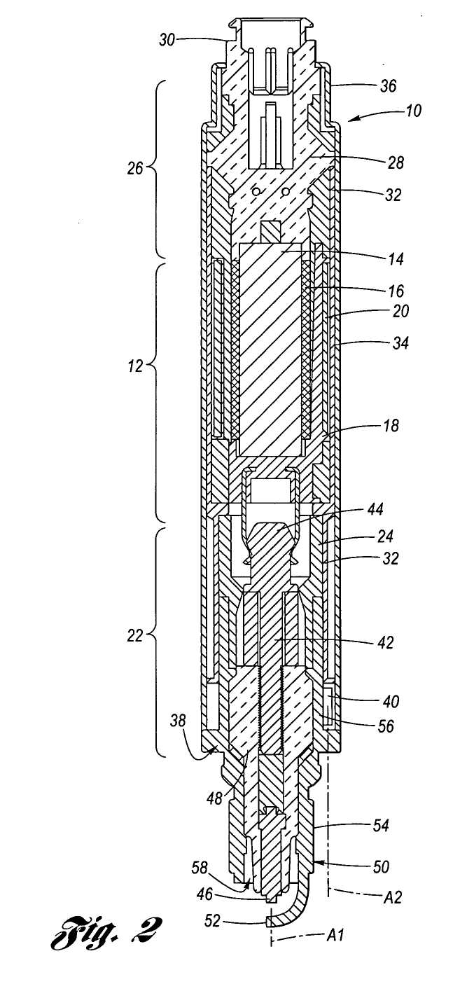

FIG. 4 is a plan view showing, in greater detail, pressure sense assembly 40. Assembly 40 includes a base plate 68 having a central body portion 70, a first tab 72, a second tab 74, a plurality of strain gauges 76₁, 76₂, 76₃, 76₄, affixation regions 78, a bridge circuit 80 of which the strain gauges are a part, and an axial load path 82.

Base plate 68 comprises a material selected for compatibility and durability with a piezoelectric thick film ink process used to form strain gauges 76₁, 76₂, 76₃, 76₄. In one embodiment, base plate comprises 430 stainless steel. Other materials, however, are possible so long as the material is matched so as to promote chemical bonding and exhibit and maintain adhesion of the printed strain gauge to the base plate through its expected life.

Opposing first and second tabs 72, 74 are configured so as to extend axially away from central body region 70. In the illustrative embodiment, the base plate 68 is affixed to shell 50 at, near or around the top and bottom edges of tabs 72, 74, designated as the affixation regions 78 (shown as “X”s in FIG. 4). In one embodiment, affixation is accomplished through welding. However, it should be understood that other conventional affixation methods (e.g., adhesives or the like) may be used and remain within the spirit and scope of the present invention.

In addition, it should be understood that the tabs are not necessary for the practice of the present invention. In particular, the concentration of the axial strain may be focused through other means, or may be omitted altogether (although with a changed sensitivity).

The purpose of affixing the base plate 68 to shell 50 at the affixation regions 78 is to establish a more defined axial strain load path 82. Load path 82 is that area of plate 68 that is subtended by the axially opposing tabs 72, 74. The geometry of base plate 68 coupled with affixation at the affixation regions 78 concentrates the strain in the axial direction, and in the axial load path 82. Of course, other approaches are possible and within the scope of the invention, although the illustrated embodiment is preferred.

Bridge circuit 80 is formed through various “printing” steps. First, a dielectric (i.e., electrically insulating) layer is printed onto base plate 80. This is shown as the outermost periphery of bridge circuit 80. Base plate 68 is, in the illustrative embodiment, electrically conductive material (i.e., 430 stainless steel), and welded to shell 50, which is also electrically conductive, and generally grounded. Thus, without an electrical insulating layer, the bridge circuit would be “shorted” to ground.

The next step involves printing the conductive layer on top of the dielectric layer. The conductive layer is also shown in FIG. 4. The conductive layer electrically connects each of the four strain gauges 76₁, 76₂, 76₃, 76₄ in a desired fashion to form bridge circuit 80.

The next step involves printing the strain gauge layers to form strain gauges 76₁, 76₂, 76₃, 76₄. In the illustrative embodiment, a first pair of strain gauges 76₁, 76₂ are formed on base plate 68 in the axial load path 82, preferably one on each side of second longitudinal axis A2. These are the main strain gauges used to detect strain changes in shell 50 corresponding to and indicative of pressure changes in the combustion cylinder. Additionally, a second pair of strain gauges 76₃, 76₄ are formed on, or are disposed, circumferentially (i.e., transversely) outwardly of the axial load/strain path 82, that is, outwardly of the area of the base plate 68 subtended by the attached first and second tabs 72, 74. The positioning in the illustrated embodiment is to configure the strain gauges 76₃, 76₄ so that they each subjected to a substantially zero or zero axial strain during operation. While the transverse strain gauges may experience a relatively small Poisson effect resulting in a slightly compressive strain, nonetheless, because of this, the strain gauges 76₃, 76₄ can be used for temperature compensation. That is, the piezoresistive material changes resistance both as a function in the change in applied strain as well as a change in temperature. When the bridge includes a pair of strain gauges subject to zero or negative principal strains , the reason remaining why a resistance change would be observed is because of a change in temperature. Using such a pair in the bridge can effectively allow one to “subtract” the effect of temperature out of the bridge circuit, leaving the output pressure signal more directly the result of changes in strain, and thus pressure (i.e., it provides a more accurate pressure signal).

Of course, it should be understood that other variations in the placement of strain gauges 76 are possible and yet remain within the spirit and scope of the present invention. An alternate embodiment may be provided wherein first and second strain gauges 76₁ and 76₂ are positioned one above the other, substantially on second axis Az.

Next, the pressure sense assembly 40 is fired to cure all printed layers. Next, the pressure sense assembly 40 is affixed, for example by way of welding, to shell 50.

Since the only the base plate has to have the desired properties suitable for piezoresistive strain gauge ink printing, the invention eliminates the need to make the entire shell 50 of such material, saving cost. Also, the foregoing eliminates the need to “fire” the entire shell, thus preserving the main spark plug insulator/shell internal seal. Additionally, the base plate 68 is flat, which avoids the complications of having to print onto a round or curved surface. Additionally, providing thermal compensation is eased, compared to the two-ink or separate chip approaches described in the Background.

The plate 68 and the shell may be mated geometrically/mechanically so as to facilitate the welding process. For one example, while shell 50 is generally round or annular around its circumference, shell 50 may be formed to include a flat region so as to more easily accept the planar base plate 68. The base plate could also be curved so as to minimize or eliminate modification to the shell 50.

FIG. 5 shows an alternate embodiment of pressure sense assembly designated 40a having a curved base plate 68a. A curved base plate 68a can be used with the conventionally annular shell 50 to facilitate matching geometries to thereby facilitate the affixation process (e.g., welding).

FIG. 6 shows yet another embodiment of a pressure sense assembly designated 40b having a base plate 68b with a centrally disposed hole 84. In this embodiment, the load, and hence the resulting strain, follows the sides of the base plate, corresponding strain gauges 76₁, 76₂ while the strain gauges 76₃, 76₄ on the top and bottom of the hole 84 experience a compressive or a near zero strain.

FIG. 7 shows yet another embodiment of a pressure sense assembly designated 40c having a base plate 68c with slot-like cutouts 86. In this embodiment, the cutouts further concentrate the carrying of the load, and hence strain, through the center, axial load path about axis A2.

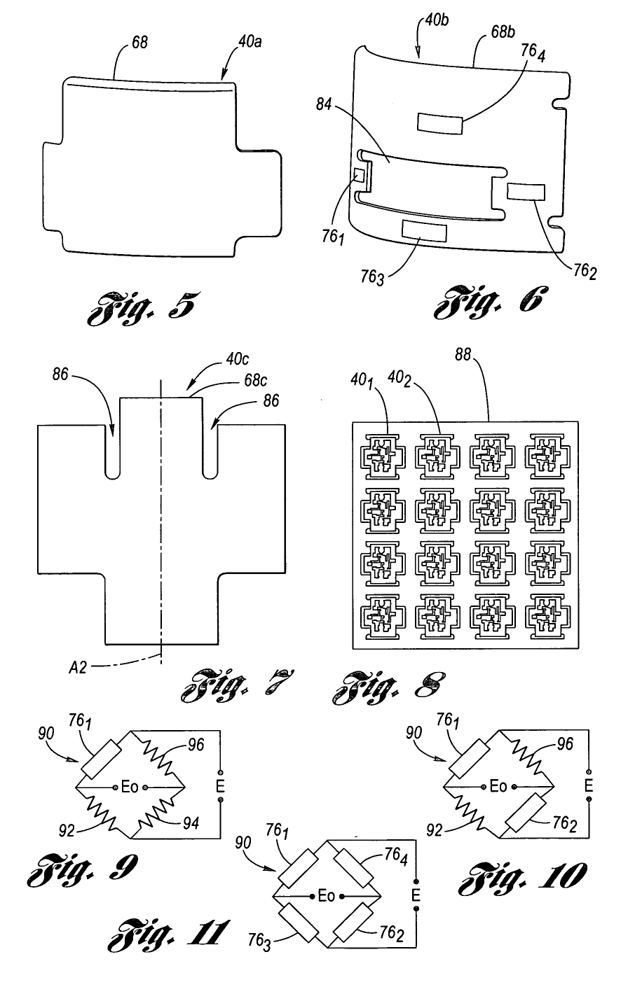

FIG. 8 is a plan view of a plate 88 having multiple pressure sense assemblies 40₁, 40₂, etc. This arrangement facilitates high volume production.

FIG. 9 shows an exemplary resistive bridge 90 including one strain gauge 76₁, and a plurality of resistors 92, 94 and 96. As arranged in FIG. 9, an input voltage designated E is applied to the bridge, as known to those of ordinary skill in the art. An output pressure signal Eo is indicative of the detected pressure in the cylinder of engine 64. Of course, it should be understood that the resistive bridge shown in FIG. 9 is simplified and is illustrated and described in exemplary terms only. More sophisticated arrangements, as well as calibration and scaling considerations, all such factors being well known to those of ordinary skill in the art, may be included and are considered within the spirit and scope of the present invention. Moreover, other conditioning circuits for detecting the resistance change presented by the strain gauge(s) may be used, and also remain within the spirit and scope of the present invention.

FIG. 10 is a simplified half bridge circuit 90a. Circuit 90a includes two active strain gauges 76₁, 76₂, but is otherwise the same as circuit 90. FIG. 11 is a simplified full bridge circuit 90b, which includes four active elements, strain gauges 76₁, 76₂, 76₃, 76₄. Circuit 90b has a first pair of opposing (on the diagonals) strain gauges 76₁, 76₂ arranged to detect positive strains and a second pair strain gauges 76₃, 76₄ arranged, for example, to provide temperature compensation. This setup could be used for opposing temperature compensation (i.e., where the pair is setup to detect zero strain). The embodiment of FIG. 11 is preferred.

It should be understood that the processing circuits may preferably be provided locally (internally) to the apparatus 10, although as mentioned below, this is not required (i.e., it could be done externally).

Referring again to FIG. 1, the assemblies 10 may be connected to the engine control unit 66. Control unit 66 may include appropriate control logic to use the pressure information detected by pressure sense assembly 40. The present invention may be configured to detect cycle-to-cycle pressure information and generate a respective pressure signal indicative of the detected pressure for each cylinder. Such plurality of pressure signals may be used by engine control unit 66 for calibrating engines to achieve improved performance with regard to fuel economy and exhaust emissions, while reducing indicated mean effective pressure (IMEP) variation. The output pressure signals may prove useful for closed-loop feedback control of combustion. Such control includes locating a peak cylinder pressure (e.g., with respect to top dead center—TDC), controlling cycle-by-cycle variation in IMEP and monitoring rate of pressure rise for each cylinder. In addition, one or more of the pressure signals may be used to detect misfire, knocking, or pre-ignition for a cylinder on an event-by-event basis. Additionally, positive control of spark timing, spark energy, air-fuel ratio, and charge dilution are possible using one or more of the pressure signals to thereby provide improvements in engine stability while reducing fuel consumption and exhaust emissions.

A more detailed description of the integrated ignition coil/spark plug embodiment of FIG. 2 will now be set forth to facilitate those of ordinary skill in the art to practice the present invention.

With reference to FIG. 2, assembly 10 has a substantially rigid outer housing 34 at one end of which is the spark plug assembly 38 and at the other end of which is the control circuit interface portion 30 for external electrical interface with a control unit 66, such as an engine control unit. The primary and secondary windings 16, 18 are arranged in a substantially coaxial fashion along with a high permeability magnetic core 14. All high voltage ignition system components are housed or are part of the integrated ignition coil, spark plug, and pressure sensor assembly 10. Generally, the structure is adapted for drop in assembly of components and sub-assemblies as later described.

Transformer portion 12 and control-circuit portion 26, which are provided for high-voltage generation, are inserted into outer housing 34. The control-circuit portion 26 responds to instruction signals from an external circuit (not shown) to cause a primary current to initially flow through primary coil 16 and then be interrupted when a spark is desired. The control circuit 26 may be external to the integrated coil/spark plug assembly 10. Connecting portion 22, which supplies a relatively high secondary voltage generated by the transformer portion 12 to the spark plug 38, is provided in a lower portion of the outer housing 34.

The outer housing 34 may be formed from round tube stock for example comprising nickel-plated 1008 steel or other adequate magnetic material. Where higher strength may be required, such as for example in unusually long cases, a higher carbon steel or a magnetic stainless steel may be substituted. A portion of the outer housing 34 at the end adjacent to the control circuit interface portion 30 may be formed by a conventional swage operation to provide a plurality of flat surfaces, thereby providing a fastening head 36, such as a hexagonal fastening head for engagement with standard sized drive tools. Additionally, the extreme end is rolled inward to provide necessary strength for torque applied to the fastening head 36 and perhaps to provide a shelf for trapping a ring clip between the outer housing 34 and the connector body 30. The previously assembled primary and secondary sub-assemblies are loaded into the outer housing 34 from the spark plug end to a positive stop provided by the swaged end acting on a top end portion of the connector body.

The transformer portion 12 is formed around the central magnetic core 14. The magnetic core 14 may be manufactured from plastic coated (insulated) iron particles in a compression molding operation. After the core 14 is molded, it is finish machined such as by grinding to provide a smooth surface absent, for example, sharp mold parting lines otherwise detrimental to the intended direct primary coil winding thereon.

Core 14 may also be formed using laminated thin silicon-steel plates of differing widths so that a cross section thereof becomes substantially circular. Optionally, magnets may be included as well in the core circuit. If included, the magnets may have polarity of reversed directions of magnetic flux generated by excitation by the primary coil 16 and are disposed on both ends of core 14.

The primary coil 16 may be, as shown, wound directly on the surface of the core 14. Coil 16 may be formed from insulated wire, which may be wound directly upon the outer cylindrical surface of the core 14. The winding of the primary coil 16 directly upon the core 14 provides for efficient heat transfer of the primary resistive losses and improved magnetic coupling which is known to vary substantially inversely proportionally with the volume between the primary coil 16 and the core 14. The core 14 is preferably assembled to the interior end portion of the connector body to establish positive electrical contact between the core 14 and a core-grounding terminal. However, the specific grounding of the core 14 is not essential to the operation of the present invention. Terminal leads of primary coil 16 may be connected to insert molded primary terminals by conventional processes such as soldering. Alternative constructions are possible, for example, via use of steel laminations for core 14 in combination with the primary coil wound on a primary coil spool (not shown). The foregoing is exemplary only and not limiting in nature.

The primary sub-assembly is inserted into the secondary coil spool 18. A secondary coil 20 may then be wound onto the outer periphery of the secondary spool 18. The secondary coil 20 may be either a segment wound coil or a layer (progressive) wound coil in a manner that is known to one of ordinary skill in the art.

The control-circuit portion 26 may contain circuitry for processing the pressure indicative signal and may be made up of a molded-resin switching element which controls a conduction current through the primary coil 16 to be intermittent, and a control circuit which is an igniter that generates the control signals of this switching element. Additionally, a heat sink, which may be a separate body, may be glued or otherwise adhered to the control-circuit portion 26 for heat radiation of circuit elements such as the switching element. However, as previously mentioned, the control-circuit portion 26 may be external to the spark plug assembly 38.

The interior of housing 34 retains the transformer portion 12, connector portion 28, and a high voltage boot 24. The coil case 32 is disposed within the outer housing 34 and is added to support the coil. For the assembly process, the wound primary coil 16 with assembled connector 28 is assembled to the wound secondary spool 18 and then into the coil case 32.

The above-described ignition coil and spark plug assembly 10 is inserted in a plug hole of an internal combustion engine and is affixed to an engine. The spark plug assembly 38 that is mounted on a bottom portion of the plug hole is received within the connecting portion 22, and a high voltage terminal portion 44 of the spark plug 38 electrically contacts high voltage connector portion. The steel shield 34 may be welded to the spark plug to form a pre-assembled unit. The pre-assembled unit is then screwed into the spark plug hole in the engine head in the conventional manner. The unit may then be self-supporting with no attachment bolts required.

Spark plug assembly 38 includes central electrode 42 that extends in a generally longitudinal direction and has a main axis, designated “A1.” First end 44 of central electrode 42 is configured for connection to a relatively high voltage source (i.e., spark voltage), as known. The second end 46 of electrode 42 is exposed, and is spaced apart from ground electrode 52 to define a spark gap.

Insulator 48 is annular in configuration and is located generally radially outwardly of central electrode 42.

Annular conductive shell 50 preferably comprises metal and is disposed generally radially outwardly of insulator 48, and includes a central bore 58.

As previously mentioned the coil case 32 is disposed within the outer housing 34. The coil case 32 also contains the core 14, primary coil 16, secondary spool 18, and secondary coil 20.

The circuit interface portion 30 connects to the electrical system of the vehicle to both provide an electrical input and control of the coils, and communication of the engine control unit with the pressure sensing assembly.

The present invention, improves quality of the product because the entire shell is not subjected to the firing temperatures required by the thick film ink “printing” process, thereby preserving various seals. Also, the consistency and accuracy of the temperature compensation is improved because only one ink is needed. This is in contrast to a thermistor option, wherein a second material (or chip) is chosen which seeks to match the temperature coefficient of resistance of the piezoelectric material.

Although the present invention has been fully described in connection with the preferred embodiment thereof with reference to the accompanying drawings, it is to be noted that various changes and modifications will become apparent to those skilled in the art. Such changes and modifications are to be understood as being included within the scope of the present invention as defined by the appended claims.

1. An apparatus for detecting a pressure in a cylinder of an internal combustion engine, said apparatus comprising:
an annular shell extending along a longitudinal axis, said shell being configured for removable attachment to said engine such that a portion of said shell is subjected to the pressure in said cylinder;
a pressure sense assembly affixed to said shell, said assembly having a base plate, said base plate having a body portion, said base plate being affixed to said shell, said assembly including at least one strain gauge formed thereon.

2. The apparatus of claim 1 wherein said body portion has first and second tabs extending axially away from said body portion, said first and second tabs of said base plate being affixed to said shell.

3. The apparatus of claim 2 wherein said apparatus comprises a spark plug and said engine comprises a spark ignition internal combustion engine.

4. The apparatus of claim 1 wherein said apparatus comprises a glow plug and said engine comprises a diesel cycle internal combustion engine.

5. The apparatus of claim 3 further including a central electrode coaxial with and surrounded by said annular shell, said electrode having a first end configured for connection to a relatively high voltage source and a second, exposed end opposite said first end, an insulator outwardly of said central electrode, said shell being radially outwardly of said insulator and electrically conductive, a second electrode spaced apart from said second end of said central electrode to define a spark gap there between, said second electrode being electrically connected to said shell.

6. The apparatus of claim 5 further including a second longitudinal axis generally parallel to and offset from said first longitudinal axis extending through said base plate through said first and second tabs, wherein said at least one strain gauge being disposed on a first side of said second longitudinal axis and a second strain gauge being disposed on a second side of said second longitudinal axis opposite said first side, said first and second strain gauges being configured to detect an axial strain of said shell.

7. The apparatus of claim 6 wherein said pressure sense assembly further includes third and fourth strain gauges formed on said base plate on opposing sides of said second longitudinal axis.

8. The apparatus of claim 7 wherein said base plate is unattached to said shell other than at said first and second tabs, wherein said third and fourth strain gauges are disposed circumferentially outwardly of an area of said base plate subtended in an axial direction by said first and second tabs.

9. The apparatus of claim 7 wherein said base plate is unattached to said shell other than at said first and second tabs, wherein said third and fourth strain gauges are disposed circumferentially outwardly of an area of said base plate subtended in an axial direction by said first and second tabs.

10. The apparatus of claim 9 wherein said base plate comprises stainless steel material.

11. The apparatus of claim 10 wherein said pressure signal is configured for transmission to a controller that is coupled to said bridge circuit and which is configured to process said pressure signal.

12. The apparatus of claim 5 further including an ignition coil coupled to said first end of said central conductor configured to generate said relatively high voltage.

13. The apparatus of claim 1 wherein said base plate is curved.

14. The apparatus of claim 1 wherein said base plate includes a hole.

15. The apparatus of claim 1 wherein said shell includes a flat region, said base plate being planar.

16. A spark generating assembly for initiating combustion and detecting a pressure in a cylinder of an internal combustion engine, said assembly comprising:
a central electrode having a main axis and a first end configured for connection to a relatively high voltage source;
an insulator radially outwardly of said central electrode, said central electrode further having a second, exposed end axially opposite said first end;
an annular shell extending along said main axis, said shell being configured for removable attachment to said engine such that a portion of said shell is subjected to the pressure in said cylinder;
a second electrode spaced apart from said second end of said central electrode to define a spark gap there between, said second electrode being electrically coupled to said shell; and
a pressure sense assembly affixed to said shell, said pressure sense assembly having a base plate, said base plate having a central body portion said plate being affixed to said shell, said assembly including at least one strain gauge formed thereon.

17. The assembly of claim 16 wherein said central body portion has first and second opposing tabs extending axially away from said central body portion, said first and second tabs being affixed to said shell.

18. The assembly of claim 17 further including a second longitudinal axis generally parallel to and offset from said first longitudinal axis extending through said base plate through said first and second tabs, wherein said at least one strain gauge being disposed on a first side of said second longitudinal axis and a second strain gauge being disposed on a second side of said second longitudinal axis opposite said first side, said first and second strain gauges being configured to detect an axial strain of said shell.

19. The assembly of claim 18 wherein said pressure sense assembly further includes third and fourth strain gauges formed on said base plate on opposing sides of said second longitudinal axis.

20. The assembly of claim 19 wherein said base plate is unattached to said shell other than at said first and second tabs, wherein said third and fourth strain gauges are disposed circumferentially outwardly of an area of said base plate subtended in an axial direction by said first and second tabs.

21. The assembly of claim 20 further comprising a bridge circuit electrically connected to said first, second, third and fourth strain gauges configured to generate a pressure signal indicative of said pressure in said combustion cylinder of said internal combustion engine.

22. The assembly of claim 21 wherein said base plate comprises stainless steel material.

23. The assembly of claim 22 wherein said pressure signal is configured for transmission to a controller that is coupled to said bridge circuit and which is configured to process said pressure signal.

24. The assembly of claim 23 further including an ignition coil coupled to said first end of said central conductor configured to generate said relatively high voltage.

25. The assembly of claim 24 wherein said base plate is planar, said shell including a flat region configured to receive said base plate.
